(19) United States
(12) Patent Application Publication
(10) Pub. No.: US 2008/0061739 A1
(43) Pub. Date: Mar. 13, 2008

(54) Portable charging device capable of outputting voltage

(76) Inventor: Sheng-Fu Lu, Tashi Town (TW)

Correspondence Address: TROXELL LAW OFFICE PLLC, Suite 1404, 5205 Leesburg Pike, Falls Church, VA, 22041, US

(21) Appl. No.: 11/518,402

(22) Filed: Sep. 11, 2006

(51) Int. Cl. H02J 7/00

(52) U.S. Cl. 320/114

(57) ABSTRACT

A portable charging device capable of outputting voltage comprises a charger base, a power supply and a solar panel. The power supply and the solar panel are insertable into the charger base for inputting voltage to the charger base. The charger base is designed for charging rechargeable batteries and supplying various voltages for built-in or external electronic products.

### FIELD OF THE INVENTION

The present invention relates to a portable charging device capable of outputting voltage, and more particularly to a portable charging device that charges rechargeable batteries through a power supply and a solar panel and that has power output sockets for supplying electric power for external electronic products so as to provide multiple supplementary functions, reduce energy consumption, and protect environment against secondary pollution.

### BACKGROUND OF THE INVENTION

The commercial electric power, which acts as a charging source, is usually applied to a general charger. The commercial electric power is a steady power source. However, different countries have different voltage specifications and the charger cannot be applied for charging at any place. As a result, it is still not convenient enough. There is disclosed a charger for connection with the car power. This kind of charger is more convenient than the charger, which is only adaptable to the commercial electric power. However, it is still imperfect since its usage is restricted to the inside of the car.

Nowadays, the skilled person has disclosed the solar charger. The solar charger is portable, energy-saving and suitable for instantaneous charging. However, the solar charger is still affected by the seasons, the weather, and the darkness. Accordingly, the solar charger cannot supply the electric power persistently. Besides, the photo-to-electricity conversion efficiency of the solar charger is poor.

As a result, the present invention desires to provide an integrated charging device with multiple supplementary functions.

### SUMMARY OF THE INVENTION

It is a main object of the present invention to provide a portable charging device capable of outputting voltage, which comprises a charger base, a power supply and a solar panel. The power supply and the solar panel are insertable into the charger base for inputting voltage to the charger base. The charger base is designed for charging rechargeable batteries and supplying various voltages for built-in or external electronic products.

By means of the above-mentioned device, the present invention can overcome the conventional drawbacks and is capable of reducing the energy consumption and protecting the environment from secondary pollution so as to satisfy requirement for environmental protection.

### BRIEF DESCRIPTION OF THE DRAWINGS

FIG. 1 is an elevational diagram showing a charger base of the present invention.

FIG. 2 is an elevational diagram showing that a liftable cover of the charger base of the present invention is lifted up.

FIG. 3 is an elevational, exploded diagram showing the internal structure of the charger base of the present invention.

FIG. 4 is a schematic diagram showing that the charger base charges AA-type Ni—H batteries.

FIG. 5 is a schematic diagram showing that the charger base charges AAA-type Ni—H batteries.

FIG. 6 is another elevational diagram showing the charger base of the present invention.

FIG. 7 is a block diagram showing the circuit of the present invention.

FIG. 8 is a block diagram showing the power output circuit in accordance with a preferred embodiment of the present invention.

### DETAILED DESCRIPTION OF THE PREFERRED EMBODIMENT

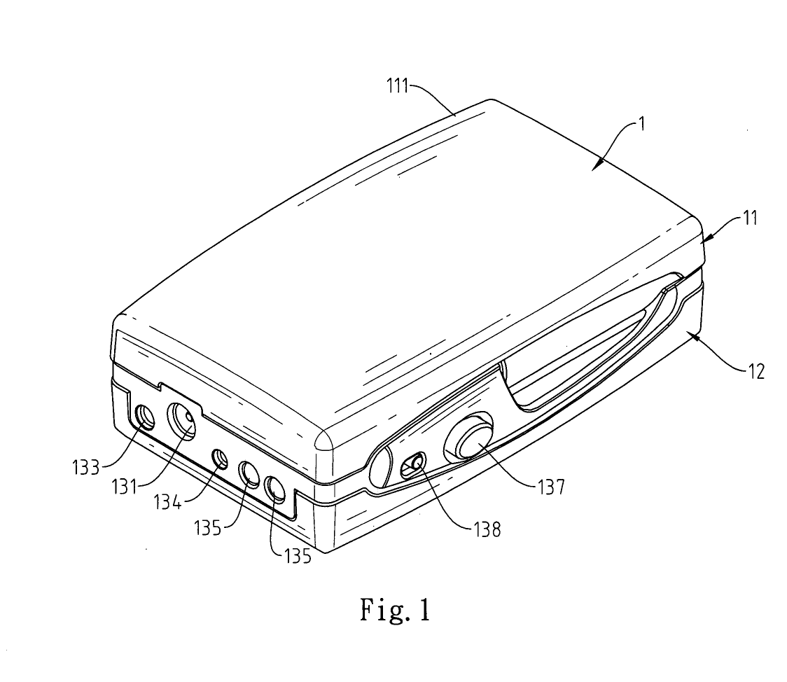

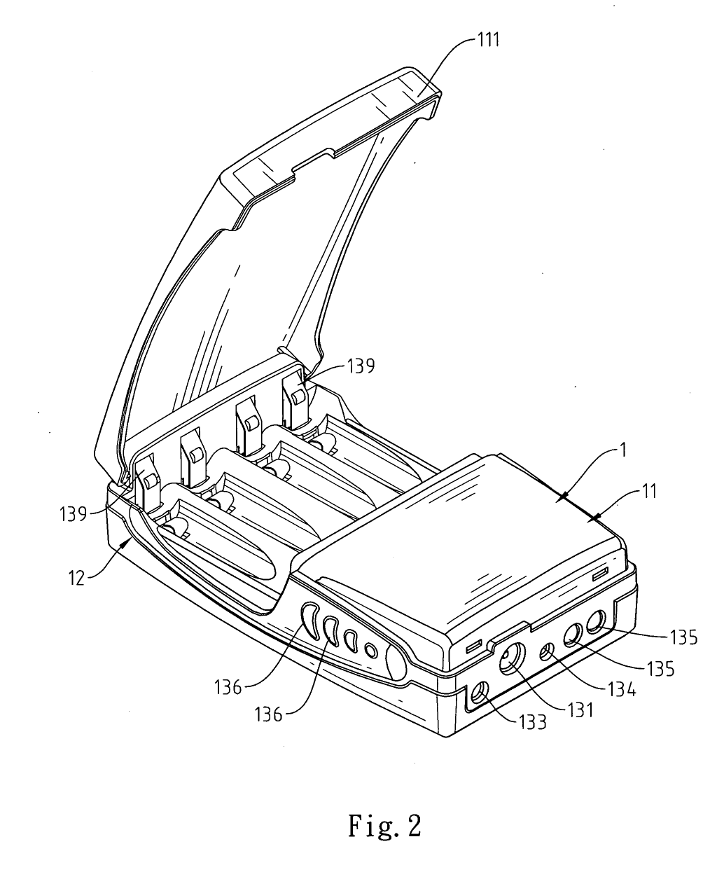

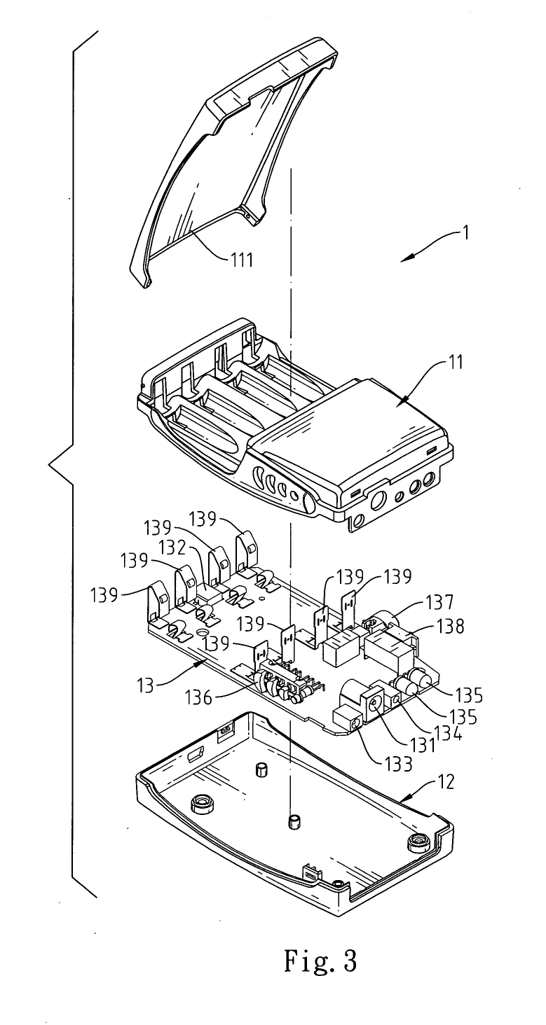

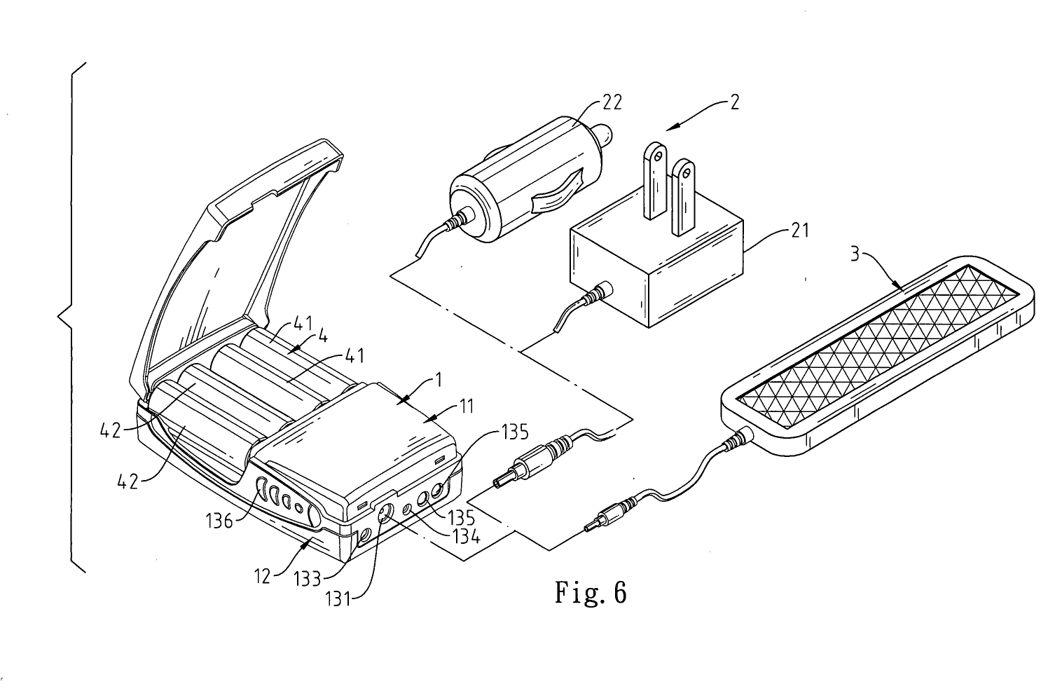

Referring to FIGS. 1 through 3 and 6, a portable charging device capable of outputting voltage of the present invention is capable of charging rechargeable batteries, and comprises a charger base 1, a power supply 2 and a solar panel 3. In accordance with a preferred embodiment, the portable charging device is applied for charging four rechargeable batteries 4, which are divided into two groups including a first rechargeable battery group 42 and a second rechargeable battery group 41.

The charger base 1 comprises a shell 11, a bracket 12, and a circuit control device 13. One lateral surface of the shell 11 is covered with a liftable cover 111. The other lateral surface of the shell 11 is attached to the bracket 12. The circuit control device 13 is mounted between the bracket 12 and the shell 11. The circuit control device 13 comprises a power input socket 131, a USB power input socket 132, a first power output socket 133, a second power output socket 134, several light sources 135, several charging status indicator lights 136, a lighting control button 137, a switch 138, and a charging module 139, wherein the power input socket 131 and the USB power input socket 132 are reserved for insertion thereinto of the power supply 2 and the solar panel 3, respectively. The first power output socket 133 and the second power output socket 134 are designed for raising the voltage and supplying the necessary electric power for the external electronic products such as stun stick, handheld computer, PDA, digital camera, GPS, MP3, and so on.

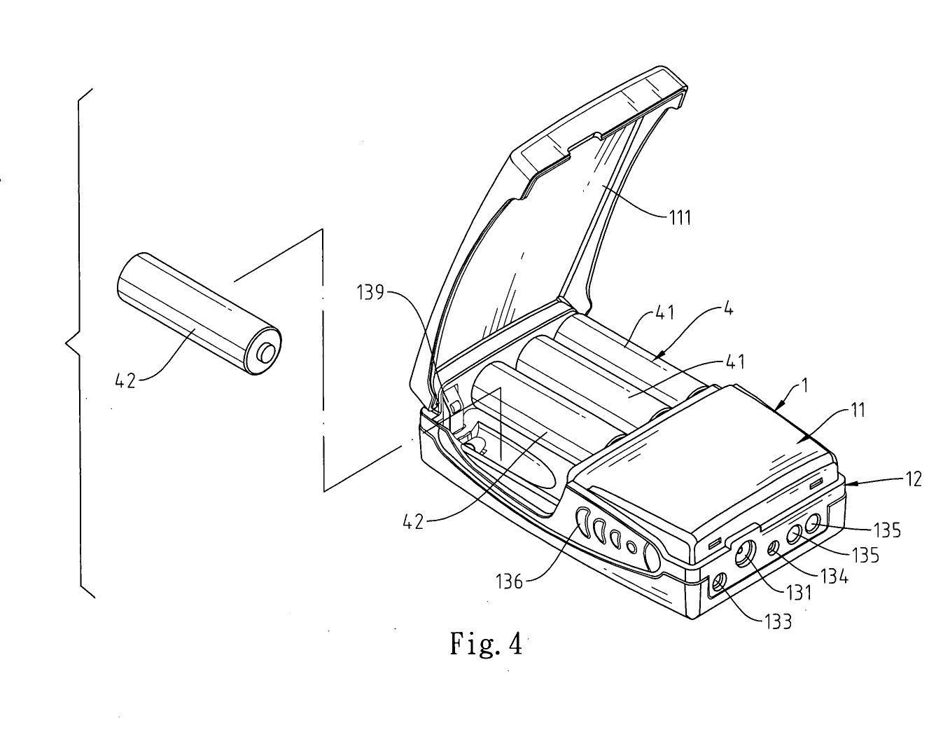

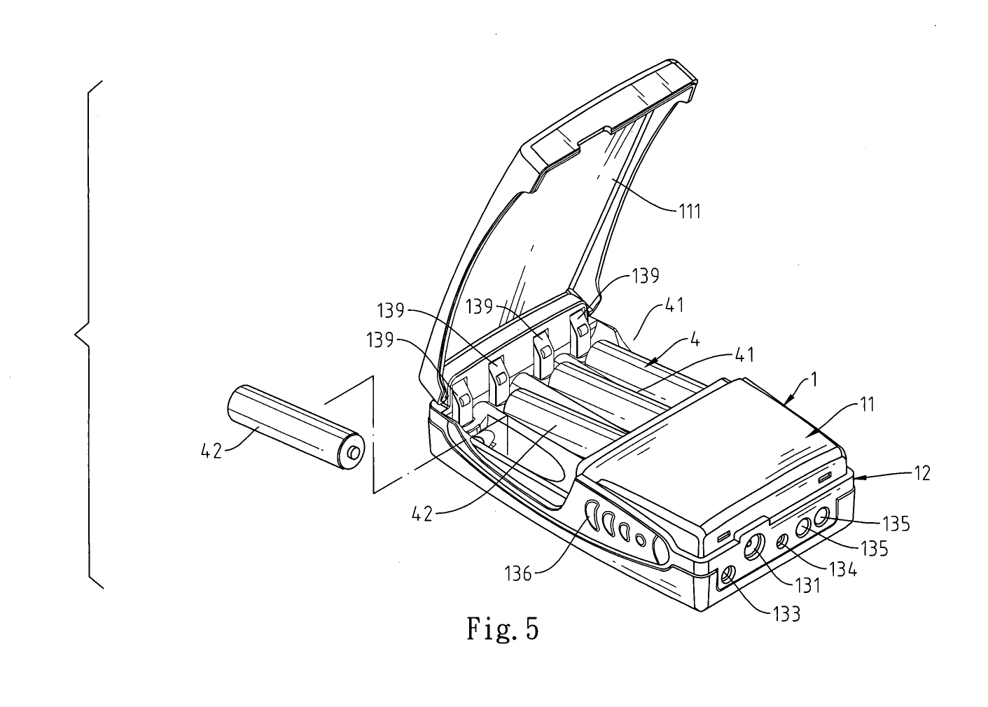

The aforesaid light sources 135 are supplied with the electric power by the rechargeable batteries 4, and can be switched on and off by controlling the lighting control button 137. The charging module 139 is designed for charging AA-type and AAA-type Ni—H batteries (rechargeable batteries), as shown in FIGS. 4 and 5. In addition, the charging status of the rechargeable batteries can be shown by changing the color of the charging status indicator lights 136. The lighting of the charging status indicator lights 136 is turned off if no rechargeable battery is mounted in the charging module 139. Besides, the rechargeable batteries 4 that need recharge can be charged by controlling the switch 138.

The power supply 2 comprises an AC-DC transformer 21 and a car-use power adapter 22, wherein the AC-DC transformer 21 can be electrically connected to the commercial electric power for reducing and transforming the AC power 100V-240V into the DC power 9V-12V in such a way that the DC power is applicable to the charging module 139 for charging at least one of the first rechargeable battery group 42 and the second rechargeable battery group 41. The car-use power adapter 22 can be electrically connected to the car power for supplying the DC power 12V-13.8V for the charging module 139 so as to charge at least one of the first rechargeable battery group 42 and the second rechargeable battery group 41. In addition, the charging status indicator lights 136 can show the charging statuses of the rechargeable batteries by changing colors. For example, red color indicates that the rechargeable batteries are in charging process and green color indicates that the charging process is completed. In this regard, the user is enabled to recognize the charging status distinctly and rapidly.

The solar panel 3 can absorb the solar energy to allow the charging module 139 to charge the first rechargeable battery group 42 or the second rechargeable battery group 41. In addition, the charging status indicator lights 136 can show the charging statuses of the rechargeable batteries by changing colors. For example, red color indicates that the rechargeable batteries are in charging process and green color indicates that the charging process is completed so as to enable the user to recognize the charging status distinctly and rapidly.

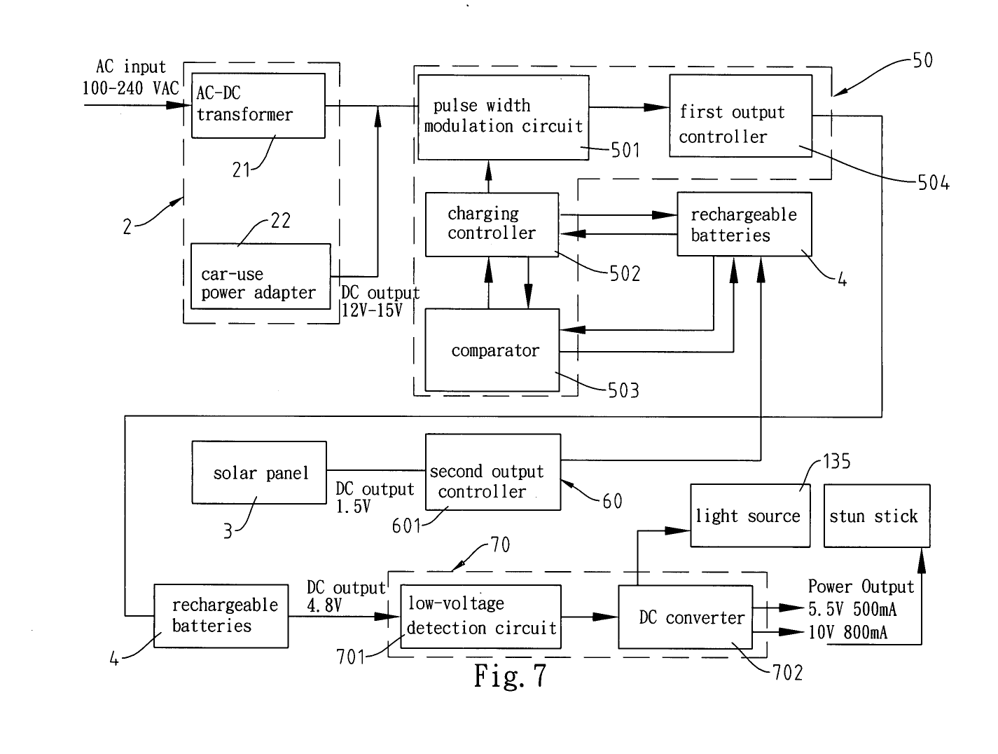

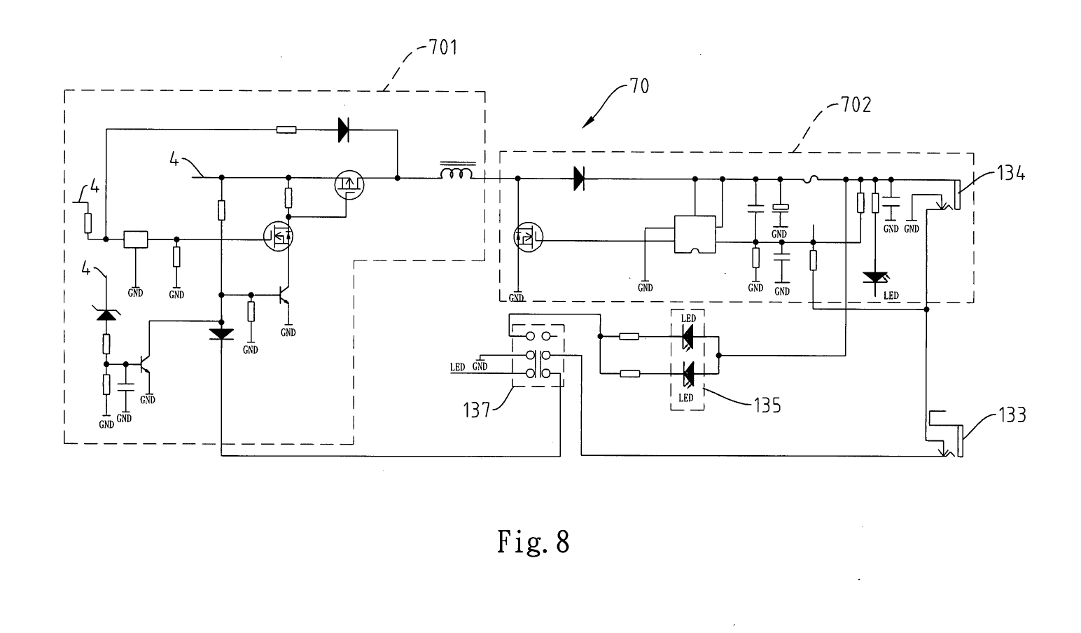

It deserves to be specially noted that the outputted voltage of the solar panel 3 is obviously lower than that of the power supply 2. As a result, they perform the charging process through different circuits. In addition, the first power output socket 133 and the second power output socket 134 are designed to be applied to built-in or external electronic products so an additional voltage-transforming circuit is required to transform the voltage. Referring to FIGS. 7 and 8 simultaneously, the circuit control device 13 has a first charge control circuit 50, a second charge control circuit 60, and a power output circuit 70, wherein the power supply 2 is electrically connected to the first charge control circuit 50 through the power input socket 131 and the solar panel 3 is electrically connected to the second charge control circuit 60 through the USB power input socket 132 for charging the rechargeable batteries 4. The rechargeable batteries 4 are electrically connected to the power output circuit 70 for supplying various voltages to built-in or external electronic products through the first power output socket 133 and the second power output socket 134.

The aforesaid first charge control circuit 50 comprises a pulse width modulation circuit 501 (P.W.M. Control C.K.T), a charging controller 502, a comparator 503, and a first output controller 504. The pulse width modulation circuit 501 is controlled by the charging controller 502 to modulate the outputted voltage and current by the use of pulse width so as to steadily confine the outputted voltage and current to a predetermined range. Next, the outputted voltage and current are further outputted to the charging module 139 through the first output controller 504 for charging the rechargeable batteries 4. The power statuses of the rechargeable batteries 4 are detectable by the comparator 503 and transmitted back to the charging controller 502 so as to determine whether the charging process should be continued or terminated.

The aforesaid second charge control circuit 60 comprises a second output controller 601 for outputting current so as to charge the rechargeable batteries 4. It deserves to be specially noted that the outputted voltage of the solar panel 3 is so obviously lower than that of the power supply 2 that the second output controller 601 is designed to only charge some rechargeable batteries 4 of the charging module 139.

The power output circuit 70 comprises a low-voltage detection circuit 701 and a DC converter 702, wherein the low-voltage detection circuit 701 is designed for detecting the voltage and supplying the voltage of the rechargeable batteries 4 for the light sources 135. In addition, the voltage of the rechargeable batteries 4 can be raised by the DC converter 702. The DC converter 702 is electrically connected to the built-in or external electronic products through the first power output socket 133 and the second power output socket 134.

What the invention claimed is:

1. A portable charging device capable of outputting voltage comprising:
a charger base comprising a shell, a bracket, and a circuit control device, one lateral surface of said shell being attached to said bracket, said circuit control device being mounted between said bracket and said shell, said circuit control device comprising a power input socket, a USB power input socket, at least one power output socket, a charging module, a first charge control circuit, a second charge control circuit, and a power output circuit, said power input socket and said USB power input socket being electrically connected to said first charge control circuit and said second charge control circuit respectively for determining whether a charging process should be continued or terminated, said charging module being designed for holding a rechargeable battery, said rechargeable battery being electrically connected to said power output circuit, said power output circuit being electrically connected to said at least one power output socket for supplying electric power for an external electronic product;
a power supply for insertion into said power input socket to allow said charging module to perform said charging process; and
a solar panel for insertion into said USB power input socket and for receiving solar energy to allow said charging module to perform said charging process.

2. A portable charging device capable of outputting voltage of claim 1, wherein said first charge control circuit further comprises a middle pulse width modulation circuit, a charging controller, a comparator, and a first output controller, and said first charge control circuit is designed for charging said rechargeable battery located in said charging module.

3. A portable charging device capable of outputting voltage of claim 2, wherein said second charge control circuit comprises a second output controller for outputting current so as to charge said rechargeable battery directly.

4. A portable charging device capable of outputting voltage of claim 1, wherein said power output circuit comprises a low-voltage detection circuit and a DC converter, wherein said DC converter raises the voltage of said rechargeable battery and connects to said at least one power output socket for insertion thereinto of said external electronic product.

5. A portable charging device capable of outputting voltage of claim 1, wherein said power supply further comprises an AC-DC transformer and a car-use power adapter.
